(19) United States
(12) Patent Application Publication
(10) Pub. No.: US 2026/0153059 A1
(43) Pub. Date: Jun. 4, 2026

(54) EVAPORATIVE-EMISSION-CONTROL SYSTEM AND STRADDLED VEHICLE EQUIPPED WITH EVAPORATIVE-EMISSION-CONTROL SYSTEM

(71) Applicant: YAMAHA HATSUDOKI KABUSHIKI KAISHA, Iwata-shi (JP)

(72) Inventors: Shotaro KISHI, Shizuoka (JP); Takahiro MASUDA, Shizuoka (JP); Yuichiro WATANABE, Shizuoka (JP)

(21) Appl. No.: 19/403,568

(22) Filed: Nov. 28, 2025

(30) Foreign Application Priority Data
Nov. 29, 2024 (JP) 2024-208309

(51) Int. Cl. F02D 41/00

(52) U.S. Cl. CPC F02D 41/004; F02D 41/0045; F02D 2200/101

(57) ABSTRACT

An evaporative-emission-control system, including: a canister recovering an evaporated fuel generated in a fuel tank; an ambient-air-introduction passage introducing an ambient air into the canister; first and second purge passages purging a gas from the canister into the engine; first and second opening/closing valves configured to switch between a closed position and an open position; an engine-information-acquisition device acquiring an engine speed of the engine and/or a throttle-valve-opening degree; a purge-amount-calculation device configured to determine whether the first and second opening/closing valves are each in the open or closed position; and a valve control device controlling opening and closing of the first and second opening/closing valves. The purge-amount-calculation device selects a mode among a recovery mode, a first purge mode, a second purge mode, and a third purge mode. The valve control device controls the opening and closing of the first and second opening/closing valves based on the selected mode.

### CROSS-REFERENCE TO RELATED APPLICATIONS

This application is based upon and claims the benefit of priority of the prior Japanese Patent Application No. 2024-208309, filed on Nov. 29, 2024, the entire contents of which are incorporated herein by reference.

### TECHNICAL FIELD

The present teaching relates to an evaporate-emission-control system and a straddled vehicle equipped with the evaporative-emission-control system.

### BACKGROUND ART

A straddled vehicle or the like using an engine as a power source includes an evaporative-emission-control system that recovers an evaporated fuel generated by evaporation of a fuel in a fuel tank. The evaporative-emission-control system includes a canister that is connected to the fuel tank and to an intake passage of the engine via respective purge pipes. The evaporative-emission-control system adsorbs the evaporated fuel, which flows into the canister from the fuel tank via the purge pipe, by means of activated carbon within the canister. The evaporative-emission-control system purges the evaporated fuel adsorbed by the activated carbon into the intake passage of the engine together with an ambient air introduced through an ambient air inlet of the canister. That is, a gas containing the evaporated fuel is purged into the intake passage. The evaporated fuel purged from the evaporative-emission-control system into the intake passage is combusted in the engine.

In the evaporative-emission-control system, the concentration of the evaporated fuel contained in the gas purged into the intake passage increases as an amount of the evaporated fuel adsorbed in the canister increases. In addition, the pressure in the intake passage decreases as the engine speed of the engine or the throttle-valve-opening degree of the throttle valve decreases. Therefore, an amount of the gas purged from the canister into the intake passage increases as the engine speed or the throttle-valve-opening degree decreases. On the other hand, an amount of fuel supplied to the engine decreases as the engine speed or the throttle-valve-opening degree decreases.

For example, in a relatively low engine speed range (during low load) of approximately 2,000 rpm to 3,000 rpm, when the evaporated fuel is purged from the canister into the intake passage of the engine, the greater an amount of the evaporated fuel adsorbed in the canister, the greater an amount of the evaporated fuel purged from the canister into the intake passage. Therefore, fluctuation in the air-fuel ratio of the engine due to the purge of the evaporated fuel becomes larger.

To address this, Patent Document 1 discloses a purge controller for evaporated fuel gas that suppresses an amount (purge amount) of the evaporated fuel purged into the intake passage during low load to avoid deterioration in engine drivability and exhaust emissions due to fluctuation in the air-fuel ratio. In the purge controller described in Patent Document 1, two inlet ports having different passage areas (effective-cross-sectional areas) and an activated carbon canister are connected by purge hoses. When the engine load is low, the purge controller purges a gas containing an evaporated fuel through a small-diameter inlet port, and when the engine load is high, purges the gas through a large-diameter inlet port. In this manner, by selectively switching between the two inlet ports based on the engine load, an amount of the evaporated fuel purged into the intake passage of the engine is restricted.

### CITATION LIST

### Patent Document

Patent Document 1: Japanese Patent Application Publication No. 61-268861

### SUMMARY OF INVENTION

### Technical Problem

The small-diameter inlet port is used in an engine speed range lower than relatively high engine speeds at which, even when the gas is purged into the intake passage through the large-diameter inlet port, the air-fuel ratio of the engine fluctuates within an allowable range. The passage area of the small-diameter inlet port is set to a size that suppresses the purge amount purged into the intake passage so that the air-fuel ratio of the engine fluctuates within an allowable range. Thus, the purge controller suppresses an amount of the gas purged by using the small-diameter inlet port in a relatively low engine speed range so that the air-fuel ratio fluctuates within an allowable range.

When the total purge amount, which is an amount of evaporated fuel contained in the gas purged into the intake passage of the engine within a predetermined time period, is less than the total amount of evaporated fuel newly generated in the fuel tank within the predetermined time period, an amount of evaporated fuel adsorbed in the canister increases. Accordingly, when the adsorbed amount of evaporated fuel reaches an upper limit, the canister is unable to adsorb an evaporated fuel newly generated in the fuel tank. Thus, it becomes difficult for the purge controller to ensure a sufficient total purge amount to process the evaporated fuel newly generated in the fuel tank, when an amount of the gas purged is suppressed. In addition, hybrid vehicles capable of electric drive operate the engine less frequently for fuel combustion, compared to conventional engine-driven vehicles. These necessitate an increase in the total purge amount.

It is, therefore, an object of the present teaching to provide an evaporative-emission-control system configured to maintain a total purge amount necessary for continued adsorption of the evaporated fuel by the canister by efficiently releasing the evaporated fuel from the canister, while suppressing fluctuation in the air-fuel ratio of the engine so that the air-fuel ratio fluctuates within a predetermined range, and a straddled vehicle equipped with the evaporative-emission-control system.

### Solution to Problem

The inventors of the present teaching have studied an evaporative-emission-control system that maintains a total purge amount necessary for continued adsorption of the evaporated fuel by the canister by efficiently releasing the evaporated fuel from the canister, while suppressing fluctuation in the air-fuel ratio of the engine so that the air-fuel ratio fluctuates within a predetermined range, and a straddled vehicle equipped with the evaporative-emission-control system. As a result of diligent examination, the inventors have arrived at the following configuration.

An evaporative-emission-control system according to one embodiment of the present teaching includes: a canister configured to recover an evaporated fuel generated in a fuel tank that stores a fuel of an engine; a fuel-tank-purge passage configured to guide the evaporated fuel into the canister; an ambient-air-introduction passage configured to introduce an ambient air into the canister; a first purge passage and a second purge passage, configured to purge a gas from the canister into an intake passage of the engine, the gas from the canister containing at least one of the recovered evaporated fuel or the ambient air introduced via the ambient-air-introduction passage; a first opening/closing valve configured to switch between a closed position in which the first purge passage is blocked and an open position in which the first purge passage is open; a second opening/closing valve configured to switch between a closed position in which the second purge passage is blocked and an open position in which the second purge passage is open; an engine-information-acquisition device configured to acquire at least one of an engine speed of the engine or a throttle-valve-opening degree of the engine; a purge-amount-calculation device configured to determine whether each of the first opening/closing valve and the second opening/closing valve is in the open position thereof or the closed position thereof; and a valve control device configured to control opening and closing of each of the first opening/closing valve and the second opening/closing valve, to thereby form a plurality of purge passages through which the gas passes in the evaporative-emission control system. Each of the plurality of purge passages has an effective-cross-sectional area. The plurality of purge passages includes the first purge passage and the second purge passage. The effective-cross-sectional area of the first purge passage is a first effective-cross-sectional area, which is smallest among the effective-cross-sectional areas of the plurality of purge passages. The effective-cross-sectional area of the second purge passage is a second effective-cross-sectional area, which is obtained by subtracting the first effective-cross-sectional area from a third effective-cross-sectional area, the third effective-cross-sectional area being a sum of the effective-cross-sectional areas of the plurality of the purge passages. The purge-amount-calculation device is configured to select, based on at least one of the engine speed or the throttle-valve-opening degree acquired by the engine-information-acquisition device, a mode among: a recovery mode in which the first opening/closing valve is switched to, and remains in, the closed position, and the second opening/closing valve is switched to, and remains in, the closed position, to thereby recover the evaporated fuel by the canister without supplying the evaporated fuel to the engine, a first purge mode in which the first opening/closing valve is switched to, and remains in, the open position, and the second opening/closing valve is switched to, and remains in, the closed position, to thereby supply the gas to the engine through the first purge passage, a second purge mode in which the first opening/closing valve is switched to, and remains in, the closed position, and the second opening/closing valve is switched to, and remains in, the open position, to thereby supply the gas to the engine through the second purge passage, and a third purge mode in which the first opening/closing valve is switched to, and remains in, the open position, and the second opening/closing valve is switched to, and remains in, the open position, to thereby supply the gas to the engine through the first purge passage and the second purge passage. The valve control device is configured to control the opening and closing of the first opening/closing valve and the second opening/closing valve in accordance with the selected mode.

In the above-described configuration, the evaporative-emission-control system has a two-level switching method in which one of the first opening/closing valve or the second opening/closing valve is switched to the open position and the other to the closed position and are held in their respective positions, to thereby change an amount of the gas purged into the intake passage to a small amount or an intermediate amount. Furthermore, the evaporative-emission-control system has a multi-level switching method for selecting one of a first level in which both the first and second opening/closing valves are switched to the closed position and held there, a second level in which the first opening/closing valve is switched to the open position and held there and the second opening/closing valve is switched to the closed position and held there, and a third level in which both the first and second opening/closing valves are switched to the open position and held there, to thereby change an amount of the gas purged into the intake passage to zero, a small amount, or a large amount. The evaporative-emission-control system switches the amount of the gas purged into the engine among four levels through a combination of the two-level switching method and the multi-level switching method. This enables the evaporative-emission-control system to precisely adjust the amount of the gas purged into the engine by opening and closing the two valves based on at least one of the engine speed or the throttle-valve-opening degree.

The second purge passage has the second effective-cross-sectional area obtained by subtracting the first effective-cross-sectional area from the third effective-cross-sectional area. That is, the evaporative-emission-control system purges the gas via the second purge passage, in a range between the upper limit of the engine speed or the throttle-valve-opening degree at which the gas can be purged in the first purge mode and the lower limit of the engine speed or the throttle-valve-opening degree at which the gas can be purged in the third purge mode. A cross-sectional area of the second purge passage is configured as the second effective-cross-sectional area that allows an amount of the gas to pass therethrough, the amount being within a range in which an air-fuel ratio of the engine fluctuates within an allowable range. Thus, the evaporative-emission-control system selects a purge mode based on the engine speed or the throttle-valve-opening degree, thereby releasing the evaporated fuel from the canister and purging an amount of the gas containing the evaporated fuel free from influence on the air-fuel ratio into the intake passage, in the entire changeable range of the engine speed or throttle-valve-opening degree. In this manner, the evaporative-emission-control system can precisely adjust an amount of the gas purged based on at least one of the engine speed or the throttle-valve-opening degree, compared with a case in which the gas is supplied via one of two purge passages with different effective-cross-sectional areas. Accordingly, it is possible to maintain a total purge amount necessary for continued adsorption of the evaporated fuel by the canister by efficiently releasing the evaporated fuel from the canister, while suppressing fluctuation in the air-fuel ratio of the engine so that the air-fuel ratio fluctuates within a predetermined range.

In another aspect, the evaporative-emission-control system according to the present teaching may have the following configuration. The first purge passage allows an amount of the gas containing the evaporated fuel to pass therethrough, to thereby maintain continued combustion in the engine, in at least one of a state where the engine speed is equal to or greater than an idle speed or a state where the throttle-valve-opening degree is equal to or greater than an opening degree for maintaining the idle speed.

In the above-described configuration, while the engine operates at an idle speed, for example, the evaporative-emission-control system enables the engine to appropriately continue combustion by purging the gas into the intake passage via the first purge passage. In response to an increase in the engine speed or the throttle-valve-opening degree, the evaporative-emission-control system switches the mode for purging the gas, thereby increasing an amount of the evaporated fuel purged into the intake passage while appropriately maintaining the combustion state of the engine. Accordingly, when the engine rotates at or above the idle speed, an appropriate amount of the gas can be purged into the intake passage based on at least one of the engine speed or the throttle-valve-opening degree. It is thus possible to maintain the total purge amount necessary for continued adsorption of the evaporated fuel by the canister by efficiently releasing the evaporated fuel from the canister, while suppressing fluctuation in the air-fuel ratio of the engine so that the air-fuel ratio fluctuates within a predetermined range.

In another aspect, the evaporative-emission-control system according to the present teaching may have the following configuration. The second effective-cross-sectional area is greater than the first effective-cross-sectional area.

In the above-described configuration, the second effective-cross-sectional area is greater than the first effective-cross-sectional area, which serves to increase an amount of the gas purged into the intake passage in the order of the recovery mode, the first purge mode, the second purge mode, and the third purge mode. Thus, the evaporative-emission-control system can precisely adjust an amount of the gas purged into the engine based on the engine speed and the throttle-valve-opening degree. Accordingly, it is possible to maintain the total purge amount necessary for continued adsorption of the evaporated fuel by the canister by efficiently releasing the evaporated fuel from the canister, while suppressing fluctuation in the air-fuel ratio of the engine so that the air-fuel ratio fluctuates within a predetermined range.

In another aspect, the evaporative-emission-control system according to the present teaching may have the following configuration. The engine-information-acquisition device is further configured to acquire a crankshaft angle of the engine. The valve control device is configured to control the opening and closing of each of the first opening/closing valve and the second opening/closing valve based on the crankshaft angle acquired by the engine-information-acquisition device.

In the above-described configuration, for example, each of the first opening/closing valve and the second opening/closing valve is controlled to switch to the open position immediately before opening an intake valve of the engine, while switching to the closed position immediately before closing the intake valve. This enables the evaporative-emission-control system to purge the gas into the intake passage in synchronization with the intake timing and the exhaust timing of the engine, irrespective of fluctuation in the engine speed caused by a load. It is thus possible to maintain the total purge amount necessary for continued adsorption of the evaporated fuel by the canister by efficiently releasing the evaporated fuel from the canister in accordance with the intake and exhaust timings of the engine.

In another aspect, the evaporative-emission-control system according to the present teaching may have the following configuration. The purge-amount-calculation device is configured to calculate a total amount of the evaporated fuel contained in the gas purged into the intake passage within a predetermined time period as a total purge amount, based on at least one of the engine speed or the throttle-valve-opening degree, and on the first effective-cross-sectional area or the second effective-cross-sectional area of the purge passage through which the gas passes. The purge-amount-calculation device selects the third purge mode in a case where the total purge amount is equal to or greater than a reference-total-purge amount at which fluctuation in an air-fuel ratio of the engine is suppressed so that the air-fuel ratio fluctuates within a predetermined range.

In the above-described configuration, after a predetermined time period has elapsed in the first purge mode or the second purge mode, the estimated maximum amount of the evaporated fuel adsorbed by the canister is a difference between a sum of the maximum amount of the evaporated fuel that can be adsorbed by the canister and the maximum amount of the evaporated fuel newly generated in the fuel tank within the predetermined time period, and the total purge amount that is a total amount of the evaporated fuel contained in the gas purged into the intake passage within the predetermined time period. On the other hand, a concentration of the evaporated fuel contained in the gas decreases with a decrease in the evaporated fuel adsorbed by the canister. That is, the concentration of the evaporated fuel purged into the intake passage depends on an amount of the evaporated fuel adsorbed by the canister. In addition, the maximum amount of the evaporated fuel that can be adsorbed by the canister and the maximum amount of the evaporated fuel newly generated in the fuel tank within the predetermined time period are respectively constant. Accordingly, the concentration of the evaporated fuel contained in the gas purged into the intake passage depends on the total purge amount. The concentration of the evaporated fuel contained in the gas decreases as the total purge amount increases.

When the total purge amount within the predetermined time period increases to be equal to or greater than the reference-total-purge amount in the first purge mode or the second purge mode, the valve control device determines that, even when an amount of the gas purged into the intake passage is increased, fluctuation in the air-fuel ratio of the engine is suppressed so that the air-fuel ratio fluctuates within a predetermined range. In this case, the valve control device selects the third purge mode in which the maximum amount of the gas is purged into the engine. The evaporated fuel can be more efficiently released from the canister by increasing the amount of the gas purged. In this manner, it is possible to maintain the total purge amount necessary for continued adsorption of the evaporated fuel by the canister by efficiently releasing the evaporated fuel from the canister, while suppressing fluctuation in the air-fuel ratio of the engine so that the air-fuel ratio fluctuates within a predetermined range.

A straddled vehicle including the evaporative-emission-control system according to one embodiment of the present teaching includes: an engine; a fuel tank configured to store a fuel of the engine; and an engine control device. The fuel tank is connected to the canister via the fuel-tank-purge passage. The engine has an intake passage that is connected to the canister via the first purge passage and the second purge passage. At least one of the engine speed or the throttle-valve-opening degree is transmitted from the engine control device to the engine-information-acquisition device. Alternatively, at least one of the engine speed or the throttle-valve-opening degree of the engine is acquired by the engine-information-acquisition device, the engine speed being detected by an engine speed sensor of the engine.

In the above-described configuration, the straddled vehicle transmits at least one of the engine speed or the throttle-valve-opening degree of the engine from the engine control device to the engine-information-acquisition device of the evaporative-emission-control system. The evaporative-emission-control system purges into the intake passage the gas corresponding to a purge amount calculated based on at least one of the acquired engine speed or throttle-valve-opening degree of the engine. Accordingly, irrespective of frequent fluctuations in the engine speed depending on the operating states of the straddled vehicle, it is possible to maintain the total purge amount of the evaporated fuel in the evaporative-emission-control system, while suppressing fluctuation in the air-fuel ratio of the engine so that the air-fuel ratio fluctuates within a predetermined range.

The terminology used herein is for the purpose of describing particular embodiments only and is not intended to be limiting of the teaching.

As used herein, the term “and/or” includes any and all combinations of one or more of the associated listed items.

It will be further understood that the terms “including,” “comprising” or “having” and variations thereof when used in this specification specify the presence of stated features, steps, operations, elements, components, and/or their equivalents, but do not preclude the presence or addition of one or more steps, operations, elements, components, and/or groups thereof.

It will be further understood that the terms “mounted,” “connected,” “coupled,” and/or their equivalents are used broadly and encompass both direct and indirect mounting, connecting and coupling. Further, “connected” and “coupled” are not restricted to physical or mechanical connections or couplings, and can include electrical connections or couplings, whether direct or indirect.

Unless otherwise defined, all terms (including technical and scientific terms) used herein have the same meaning as commonly understood by one having ordinary skill in the art to which this teaching belongs.

It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the teaching, it will be understood that a number of techniques and steps are disclosed. Each of these has individual benefit and each can also be used in conjunction with one or more, or in some cases all, of the other disclosed techniques.

Accordingly, for the sake of clarity, this description will refrain from repeating every possible combination of the individual steps in an unnecessary fashion. Nevertheless, the specification and claims should be read with the understanding that such combinations are entirely within the scope of the teaching.

Embodiments of an evaporative-emission-control system and a straddled vehicle equipped with the evaporative-emission-control system according to the present teaching will be herein described.

In the following description, numerous specific details are set forth in order to provide a thorough understanding of the present teaching. It will be evident, however, to one skilled in the art that the present teaching may be practiced without these specific details.

The present disclosure is to be considered as an exemplification of the teaching, and is not intended to limit the teaching to the specific embodiments illustrated by the figures or description below.

### [Straddled Vehicle]

A straddled vehicle herein refers to a vehicle in which a driver is seated while straddling the seat. Thus, the straddled vehicle includes not only two-wheeled vehicles, but also three-wheeled and four-wheeled vehicles, or other vehicles of similar configuration, as long as the driver is seated in a straddling manner.

### [Evaporative-Emission-Control System]

An evaporative-emission-control system herein refers to a system configured to combust a fuel evaporated in a fuel tank of an engine (evaporated fuel) together with an air-fuel mixture in the engine, without releasing the evaporated fuel into the atmosphere. The evaporative-emission-control system is mounted on a vehicle using an engine as a driving source. The evaporative-emission-control system includes: a canister configured to adsorb the evaporated fuel; a first purge passage and a second purge passage that connect the canister and an intake passage of the engine; a first opening/closing valve configured to open and close the first purge passage; a second opening/closing valve configured to open and close the second purge passage; an engine-information-acquisition device configured to acquire information on the engine; a purge-amount-calculation device configured to select an open or closed position of each of the first opening/closing valve and the second opening/closing valve; and a valve control device configured to control the opening and closing of the first opening/closing valve and the second opening/closing valve. The engine-information-acquisition device, the purge-amount-calculation device, and the valve control device may be included in an engine control device of the engine. The evaporative-emission-control system causes activated carbon within the canister to adsorb the evaporated fuel, which flows into the canister from the fuel tank via a purge passage. The evaporative-emission-control system is further configured to purge the evaporated fuel adsorbed by the activated carbon into the intake passage of the engine via at least one of the first purge passage or the second purge passage, together with an ambient air introduced through an ambient air inlet of the canister.

### [Open Position of Valve]

An open position of a valve herein refers to a state that allows at least a portion of fluid to pass through the valve. That is, the open position of the valve refers to any state excluding complete closure of the valve. The open position of the valve includes both a fully open state and an at least partially open state. Thus, the valve in the open position has an opening degree that allows fluid to flow through the valve.

### [Closed Position of Valve]

A closed position of a valve herein refers to a state in which the flow of fluid through the valve is completely blocked. That is, the closed position of the valve refers to complete closure of the valve. Thus, the valve in the closed position has an opening degree that blocks fluid from flowing through the valve.

### [Predetermined Range of Air-Fuel Ratio]

A predetermined range of air-fuel ratio herein refers to a range of air-fuel ratio within which the emissions of carbon monoxide, hydrocarbons, and nitrogen oxides remain within the limits of exhaust emission regulations, based on the stoichiometric air-fuel ratio at which fuel and air completely combust without excess or deficiency in the engine. When a gas containing an evaporated fuel is purged into the intake passage of the engine, the air-fuel ratio decreases.

### [Reference Value of Total Purge Amount]

A reference value of the total purge amount herein refers to a sum of the total amount of evaporated fuel newly generated in the fuel tank within a predetermined time period and the maximum amount of evaporated fuel that can be adsorbed by the canister. When the total purge amount, which is the total amount of evaporated fuel contained in the gas purged into the intake passage of the engine within the predetermined time period, reaches the reference value of the total purge amount, it is estimated that the canister is free of evaporated fuel. Accordingly, when the total purge amount reaches the reference value, it is estimated that the gas contains the evaporated fuel currently generated in the fuel tank alone. Thus, the air after the total purge amount has reached the reference value is less likely to influence the air-fuel ratio of the engine. That is, the reference value of the total purge amount serves to determine whether the gas contains an amount of evaporated fuel that is unlikely to influence the air-fuel ratio of the engine.

### [Evaporated Fuel]

An evaporated fuel herein refers to a fuel generated from an engine fuel, such as gasoline or diesel, through evaporation caused by temperature, atmospheric pressure, vibration, or similar factors.

### [Gas Passage]

A gas passage herein refers to a space through which at least one of evaporated fuel or ambient air passes in the evaporative-emission-control system. The gas passage includes: a space within an evaporated fuel passage that connects the fuel tank and the canister and is located upstream of the canister; a space within the canister; a purge passage that connects the canister and the intake passage of the engine; an ambient-air-introduction passage that introduces an ambient air; and a space within the opening/closing valve through which a gas passes.

### [Purge Passage]

A purge passage herein refers to a space through which at least one of evaporated fuel or ambient air passes in the evaporative-emission-control system, and also a passage communicating the fuel tank with the canister, and a passage communicating the canister with the intake passage.

### [Effective-Cross-Sectional Area]

An effective-cross-sectional area herein refers to the smallest cross-sectional area of a passage that includes the opening/closing valve and that allows the fluid to pass therethrough, when the passage is viewed in a flow direction of the fluid. A flow rate of fluid flowing through the passage is proportional to the effective-cross-sectional area.

### Advantageous Effects of Invention

According to one embodiment of the present teaching, it is possible to achieve an evaporative-emission-control system configured to maintain a total purge amount necessary for continued adsorption of evaporated fuel by a canister by efficiently releasing the evaporated fuel from the canister, and a straddled vehicle equipped with the evaporative-emission-control system.

### BRIEF DESCRIPTION OF DRAWINGS

FIG. 1 is a schematic view of an evaporative-emission-control system according to a first embodiment of the present teaching.

FIG. 2 is a schematic view of a state without supply of a gas to an intake pipe in the evaporative-emission-control system according to the first embodiment of the present teaching.

FIG. 3 is a schematic view of a state where the gas is supplied to the intake pipe via a first purge passage in the evaporative-emission-control system according to the first embodiment of the present teaching.

FIG. 4 is a schematic view of a state where the gas is supplied to the intake pipe via a second purge passage in the evaporative-emission-control system according to the first embodiment of the present teaching.

FIG. 5 is a schematic view of a state where the gas is supplied to the intake pipe via a third purge passage in the evaporative-emission-control system according to the first embodiment of the present teaching.

FIG. 6 is a graph showing a relationship between engine speed and effective-cross-sectional areas of purge passages in the evaporative-emission-control system according to the first embodiment of the present teaching.

FIG. 7 is a graph showing a relationship between a total purge amount in a predetermined time period and a purge mode to be selected in the evaporative-emission-control system according to the first embodiment of the present teaching.

FIG. 8 is a schematic view of a configuration of a purge pipe for the intake pipe in an evaporative-emission-control system according to a first variation of the first embodiment of the present teaching.

FIG. 9 is a schematic view of a configuration of a purge pipe for the intake pipe in an evaporative-emission-control system according to a second variation of the first embodiment of the present teaching.

FIG. 10 is a schematic view of a configuration of a purge pipe for the intake pipe in an evaporative-emission-control system according to a third variation of the first embodiment of the present teaching.

FIG. 11 is a schematic view of a configuration of a straddled vehicle including the evaporative-emission-control system, according to a second embodiment of the present teaching.

FIG. 12 is a schematic view of the evaporative-emission-control system according to the first embodiment of the present teaching, and a graph showing a relationship between engine speed and effective-cross-sectional areas of purge passages.

### DESCRIPTION OF EMBODIMENTS

Embodiments will be described hereinafter with reference to the drawings. In the drawings, the same or corresponding parts are denoted by the same reference numerals, and description thereof will not be repeated. The dimensions of components in the drawings do not strictly represent actual dimensions of the components, dimensional proportions of the components, and the like.

### First Embodiment

### Overall Configuration of Evaporative-Emission-Control System

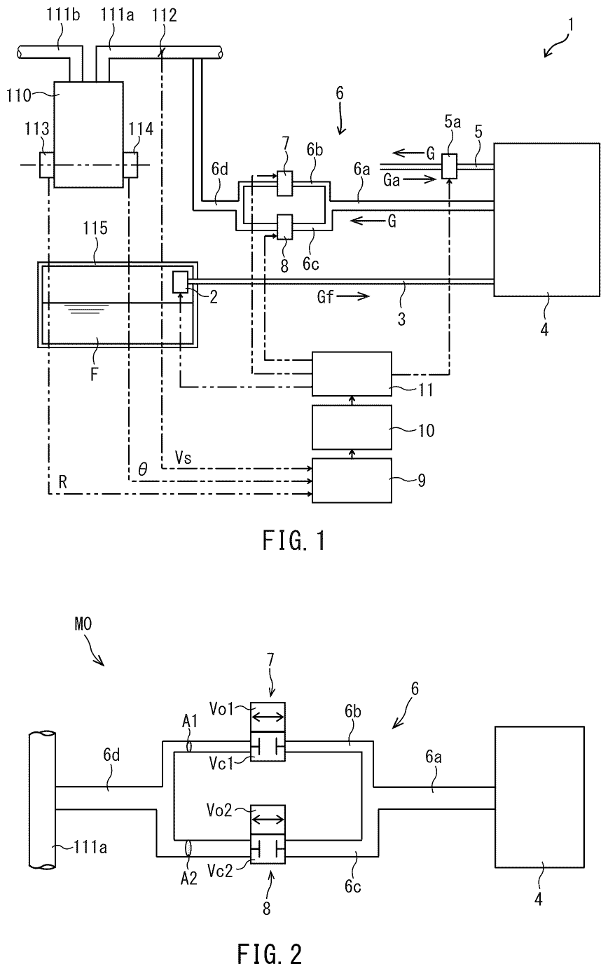

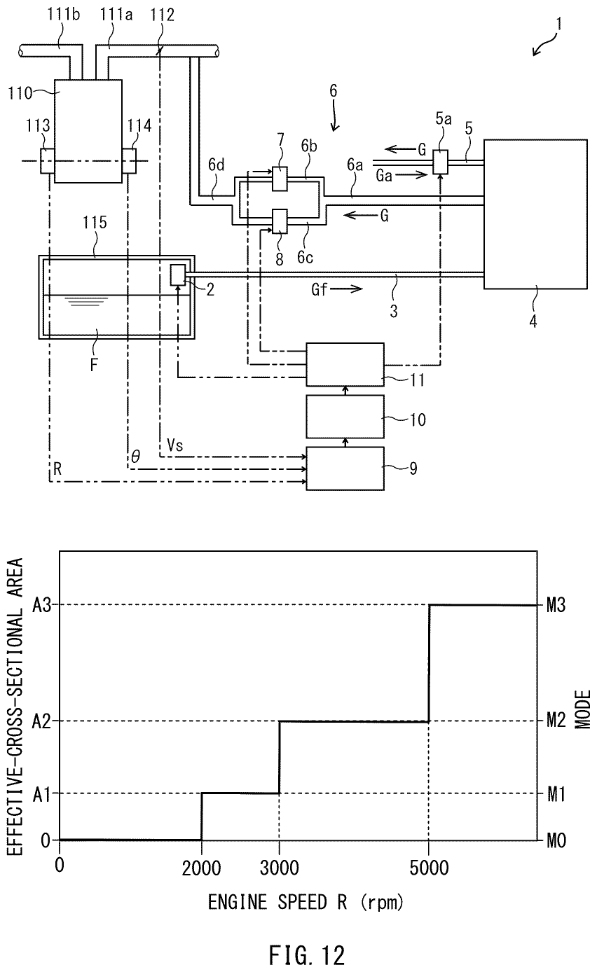

With reference to FIGS. 1 and 12, an evaporative-emission-control system 1 according to a first embodiment of the present teaching will be described. FIG. 1 is a schematic view of the evaporative-emission-control system 1 according to the first embodiment of the present teaching. FIG. 12 is a schematic view of the evaporative-emission-control system 1 and a graph showing a relationship between engine speed and effective-cross-sectional areas of purge passages.

As shown in FIGS. 1 and 12, the evaporative-emission-control system 1 is provided for an engine 110 as an internal combustion engine and a fuel tank 115 that stores a fuel F to be supplied to the engine 110. The engine 110 includes an intake pipe 111a as an intake passage for introducing an ambient air, an exhaust pipe 111b for discharging a combustion gas, a throttle valve 112 for regulating the supply amount of ambient air, an engine speed sensor 113 for detecting a rotational speed R of the engine 110 (engine speed R), and a crankshaft angle sensor 114 for detecting a crankshaft angle θ of the engine 110. The engine 110 is supplied with the fuel F from the fuel tank 115 by an unillustrated fuel supply device.

The evaporative-emission-control system 1 is configured to reduce the emission of evaporated fuel Gf generated by evaporation of the fuel F in the fuel tank 115 into the atmosphere. The evaporative-emission-control system 1 includes a shutoff valve 2, a purge pipe 3 for the fuel tank (fuel-tank-purge pipe 3), a canister 4, a vent pipe 5, a purge pipe 6 for the intake pipe (intake purge pipe 6), a first purge pipe 6b, a second purge pipe 6c, a first purge control valve 7, a second purge control valve 8, an engine-information-acquisition device 9, a purge-amount-calculation device 10, and a valve control device 11.

In the evaporative-emission-control system 1, the shutoff valve 2 is a switching valve that switches between a closed state, in which a purge passage for the fuel tank (fuel-tank-purge passage) is blocked, and an open state, in which the fuel-tank-purge passage is open, and is held in the switched position. The fuel-tank-purge passage is a passage through which a gas G containing at least one of an evaporated fuel Gf or an ambient air Ga flows. The shutoff valve 2 is an electromagnetic solenoid valve, for example. The shutoff valve 2 is connected to the fuel tank 115 that stores the fuel F. In this embodiment, the shutoff valve 2 is located within the fuel tank 115. The shutoff valve 2 is connected to one end of the fuel-tank-purge pipe 3 included in the fuel-tank-purge passage from outside of the fuel tank 115.

The shutoff valve 2 switches between the closed state in which the one end of the fuel-tank-purge pipe 3 is blocked, and the open state in which the one end of the fuel-tank-purge pipe 3 is open. The shutoff valve 2 in the closed state prevents the evaporated fuel Gf in the fuel tank 115 from flowing into the fuel-tank-purge pipe 3. The shutoff valve 2 in the open state allows the evaporated fuel Gf in the fuel tank 115 to pass through the shutoff valve 2 and flow into the fuel-tank-purge pipe 3. Thus, the shutoff valve 2 through which the evaporated fuel Gf flows constitutes a part of the fuel-tank-purge passage. The shutoff valve 2 may be located outside the fuel tank 115. The shutoff valve 2 may be supported by a component other than the fuel tank 115.

The fuel-tank-purge pipe 3, which serves as the fuel-tank-purge passage, allows the evaporated fuel Gf in the fuel tank 115 to flow into the canister 4. The other end of the fuel-tank-purge pipe 3 is connected to the canister 4. That is, the fuel-tank-purge pipe 3 connects the shutoff valve 2 and the canister 4. The fuel-tank-purge pipe 3 is switched by the shutoff valve 2 between a state in which the evaporated fuel Gf in the fuel tank 115 flows therethrough and a state in which the evaporated fuel Gf in the fuel tank 115 is prevented from flowing therethrough. Thus, the shutoff valve 2 and the fuel-tank-purge pipe 3, through which the evaporated fuel Gf and the ambient air Ga flow, constitute a part of a gas passage.

The canister 4 is a fuel adsorption device that recovers the evaporated fuel Gf. The canister 4 includes unillustrated activated carbon as an adsorbent for adsorbing the evaporated fuel Gf. The activated carbon is located in the internal space of the canister 4.

The canister 4 is connected to the other end of the fuel-tank-purge pipe 3. This allows the evaporated fuel Gf in the fuel tank 115 to flow into the canister 4 through the fuel-tank-purge pipe 3. The canister 4 is also connected to the vent pipe 5 and the intake purge pipe 6. The ambient air Ga flows into the canister 4 from the vent pipe 5. Thus, the internal space of the canister 4, into which the evaporated fuel Gf and the ambient air Ga flow, constitutes a part of the gas passage.

The vent pipe 5 serves to discharge the gas G in the canister 4 into the atmosphere and introduce the ambient air Ga into the canister 4. That is, the vent pipe 5 is configured as an ambient-air-introduction passage that introduces the ambient air Ga into the canister 4. One end of the vent pipe 5 is connected to the canister 4. The other end of the vent pipe 5 is open to the atmosphere. This enables the vent pipe 5 to introduce the ambient air Ga from the other end thereof into the canister 4. Furthermore, the vent pipe 5 can discharge the gas G remaining after the evaporated fuel Gf is adsorbed by the activated carbon in the canister 4, into the atmosphere. The vent pipe 5, through which the gas G remaining after the evaporated fuel Gf is adsorbed flows, constitutes a part of the gas passage.

A vent valve 5a is configured to switch between a closed state, in which the vent pipe 5 is blocked, and an open state, in which the vent pipe 5 is open, and to be held in the switched position. The vent valve 5a is an electromagnetic solenoid valve, for example. The vent valve 5a is provided at an arbitrary position along the vent pipe 5. When the vent valve 5a is in the open state, the evaporative-emission-control system 1 discharges the gas G free of the evaporated fuel Gf in the canister 4 into the atmosphere via the vent pipe 5. When the vent valve 5a is in the open state, the evaporative-emission-control system 1 also introduces the ambient air Ga into the canister 4 via the vent pipe 5.

The intake purge pipe 6 serves to flow the gas G containing the evaporated fuel Gf and the ambient air Ga in the canister 4 into the intake pipe 111a of the engine 110. The intake purge pipe 6 is configured as a purge passage that purges the gas G containing at least one of the evaporated fuel Gf or the ambient air Ga introduced via the vent pipe 5, into the intake pipe 111a from the canister 4.

One end of the intake purge pipe 6 is connected to the canister 4. The other end of the intake purge pipe 6 is connected to the intake pipe 111a. The intake purge pipe 6 includes a branched portion that bifurcates between the one end and the other end thereof. The intake purge pipe 6 includes an upstream purge pipe 6a that extends from the one end thereof connected to the canister 4 to the branched portion, the first purge pipe 6b and the second purge pipe 6c that constitute the branched portion, and a downstream purge pipe 6d that extends from the branched portion to the other end thereof connected to the intake pipe 111a.

One end of the upstream purge pipe 6a is connected to the canister 4. The other end of the upstream purge pipe 6a is connected to one end of the first purge pipe 6b and one end of the second purge pipe 6c. The other end of the first purge pipe 6b and the other end of the second purge pipe 6c are each connected to one end of the downstream purge pipe 6d. The other end of the downstream purge pipe 6d is connected to the intake pipe 111a. The first purge pipe 6b and the second purge pipe 6c are connected to the upstream purge pipe 6a and the downstream purge pipe 6d, respectively, such that the first purge pipe 6b and the second purge pipe 6c are arranged in parallel. That is, the first purge pipe 6b and the second purge pipe 6c are located between the upstream purge pipe 6a and the downstream purge pipe 6d. Thus, the intake purge pipe 6 through which the evaporated fuel Gf and the ambient air Ga flow constitutes a part of the gas passage.

The first purge control valve 7 as a first opening/closing valve changes a flow rate of the gas G flowing through the intake purge pipe 6. For example, the first purge control valve 7 is an on-off valve. The first purge control valve 7 is provided at an arbitrary position along the first purge pipe 6b. The first purge control valve 7 is configured to switch between a closed position Vc1, in which the first purge pipe 6b is blocked, and an open position Vo1, in which the first purge pipe 6b is open, and to be held in the switched position (see FIG. 2). That is, the first purge control valve 7 switches the first purge pipe 6b between a closed state and an open state. Thus, the first purge control valve 7 constitutes a part of the first purge pipe 6b. Furthermore, the first purge control valve 7, through which the evaporated fuel Gf and the ambient air Ga flow, constitutes a part of the gas passage.

The second purge control valve 8 as a second opening/closing valve changes a flow rate of the gas G flowing through the intake purge pipe 6. For example, the second purge control valve 8 is an on-off valve. The second purge control valve 8 is provided at an arbitrary position along the second purge pipe 6c. The second purge control valve 8 is configured to switch between a closed position Vc2, in which the second purge pipe 6c is blocked, and an open position Vo2, in which the second purge pipe 6c is open, and to be held in the switched position (see FIG. 2). That is, the second purge control valve 8 switches the second purge pipe 6c between a closed state and an open state. Thus, the second purge control valve 8 constitutes a part of the second purge pipe 6c. Furthermore, the second purge control valve 8, through which the evaporated fuel Gf and the ambient air Ga flow, constitutes a part of the gas passage.

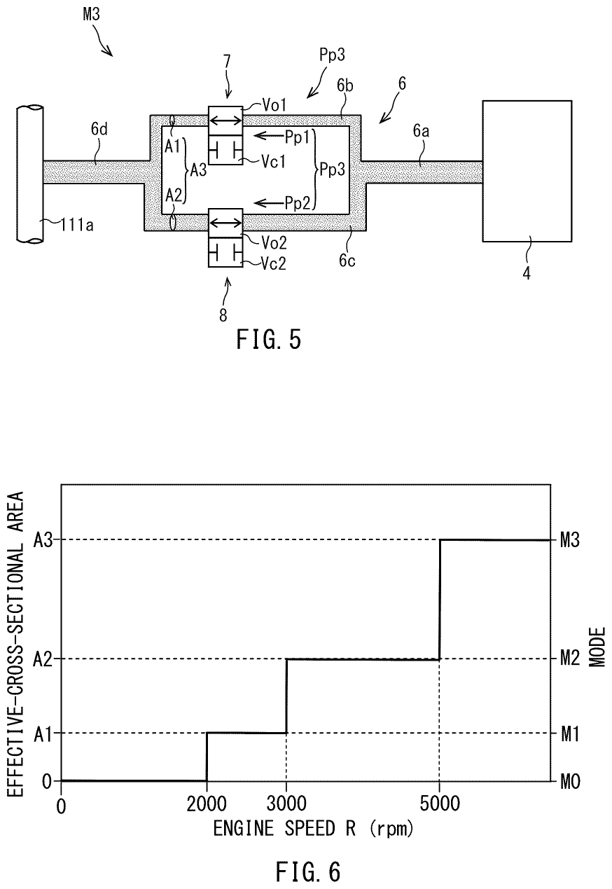

The intake purge pipe 6 constitutes a plurality of purge passages through the opening and closing of the first purge control valve 7 and the second purge control valve 8. When the first purge control valve 7 is switched to the open position Vo1 and held there and the second purge control valve 8 is switched to the open position Vo2 and held there, a third purge passage Pp3 is formed, through which the gas G passes from the canister 4 through the upstream purge pipe 6a, the first purge pipe 6b, the second purge pipe 6c, and the downstream purge pipe 6d, and is finally purged into the intake pipe 111a, in the intake purge pipe 6 (see FIG. 5).

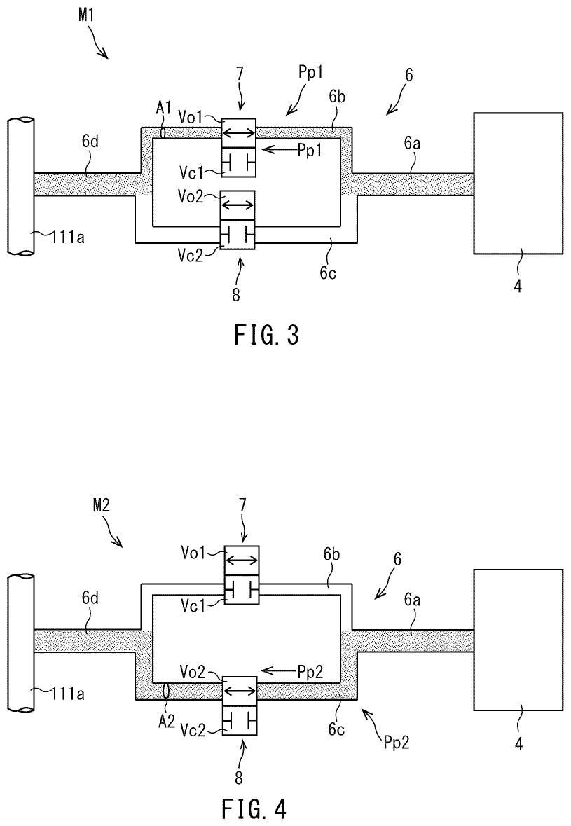

When the first purge control valve 7 is switched to the open position Vo1 and held there and the second purge control valve 8 is switched to the closed position Vc2 and held there, a first purge passage Pp1 is formed, through which the gas G passes from the canister 4 through the upstream purge pipe 6a, the first purge pipe 6b, and the downstream purge pipe 6d, and is finally purged into the intake pipe 111a, in the intake purge pipe 6 (see FIG. 3).

When the first purge control valve 7 is switched to the closed position Vc1 and held there and the second purge control valve 8 is switched to the open position Vo2 and held there, a second purge passage Pp2 is formed, through which the gas G passes from the canister 4 through the upstream purge pipe 6a, the second purge pipe 6c, and the downstream purge pipe 6d, and is finally purged into the intake pipe 111a, in the intake purge pipe 6 (see FIG. 4).

An effective-cross-sectional area of each of the purge passages is the smallest effective-cross-sectional area among cross-sectional areas of passages of the purge pipes that constitute the purge passage. An effective-cross-sectional area of the passage of the first purge pipe 6b is a first effective-cross-sectional area A1 (see FIG. 3). An effective-cross-sectional area of the passage of the second purge pipe 6c is a second effective-cross-sectional area A2 (see FIG. 4). An effective-cross-sectional area of each passage of the upstream purge pipe 6a and the downstream purge pipe 6d, which are respectively connected to the first purge pipe 6b and the second purge pipe 6c, is equal to or greater than a sum of the first effective-cross-sectional area A1 of the passage of the first purge pipe 6b and the second effective-cross-sectional area A2 of the passage of the second purge pipe 6c. The second effective-cross-sectional area A2 of the passage of the second purge pipe 6c is greater than the first effective-cross-sectional area A1 of the passage of the first purge pipe 6b.

A bifurcated portion formed by the first purge pipe 6b and the second purge pipe 6c has the smallest effective-cross-sectional area of the passage in the third purge passage Pp3 through which the gas G is purged via the first purge pipe 6b and the second purge pipe 6c. Accordingly, an effective-cross-sectional area of the third purge passage Pp3 is a third effective-cross-sectional area A3 that is the sum of the first effective-cross-sectional area A1 of the passage of the first purge pipe 6b and the second effective-cross-sectional area A2 of the passage of the second purge pipe 6c (see FIG. 5). The third purge passage Pp3 is configured to have the largest effective-cross-sectional area among the plurality of purge passages through which the gas G passes.

A portion formed by the first purge pipe 6b has the smallest effective-cross-sectional area of the passage in the first purge passage Pp1 through which the gas G is purged via the first purge pipe 6b. Accordingly, an effective-cross-sectional area of the first purge passage Pp1 is the first effective-cross-sectional area A1 of the passage of the first purge pipe 6b. The first purge pipe 6b delivers the gas G, which has passed through the upstream purge pipe 6a, into the downstream purge pipe 6d. The first purge passage Pp1 is configured to have the smallest effective-cross-sectional area among the plurality of purge passages through which the gas G passes.

A portion formed by the second purge pipe 6c has the smallest effective-cross-sectional area of the passage in the second purge passage Pp2 through which the gas G is purged via the second purge pipe 6c. Accordingly, an effective-cross-sectional area of the second purge passage Pp2 is the second effective-cross-sectional area A2 of the passage of the second purge pipe 6c. The second purge pipe 6c delivers the gas G, which has passed through the upstream purge pipe 6a, into the downstream purge pipe 6d. The second purge passage Pp2 is configured to have an effective-cross-sectional area that is less than the effective-cross-sectional area of the third purge passage Pp3, which is the largest effective-cross-sectional area among the plurality of purge passages through which the gas G passes, and greater than the effective-cross-sectional area of the first purge passage Pp1, which is the smallest.

For example, the first effective-cross-sectional area A1 of the first purge passage Pp1 is an area that allows the flow of an amount of the gas G containing the evaporated fuel Gf, the amount being within a range in which the air-fuel ratio of the engine 110 fluctuates within an allowable range, for a relatively low engine speed range (under low load conditions) from approximately 2,000 rpm (idle speed) to 3,000 rpm for the engine speed R, or its corresponding range of a throttle-valve-opening degree Vs of the throttle valve 112.

For example, the third effective-cross-sectional area A3, which is the effective-cross-sectional area of the third purge passage Pp3 formed by the entire intake purge pipe 6, is an area that allows the flow of an amount of the gas G containing the evaporated fuel Gf, the amount being within a range in which the air-fuel ratio of the engine 110 fluctuates within an allowable range, for a relatively high engine speed range (under high load conditions) of 5,000 rpm or greater including the maximum engine speed for the engine speed R, or its corresponding range of the throttle-valve-opening degree Vs.

The second effective-cross-sectional area A2 of the second purge passage Pp2 is an area obtained by subtracting the first effective-cross-sectional area A1 from the third effective-cross-sectional area A3. That is, the second effective-cross-sectional area A2 is an area that allows the flow of an amount of the gas G containing the evaporated fuel Gf, the amount being within a range in which the air-fuel ratio of the engine 110 fluctuates within an allowable range, for an engine speed range between the upper limit of the engine speed R at which the gas G passing through the first purge passage Pp1 can be purged or its corresponding throttle-valve-opening degree Vs, and the lower limit of the engine speed R at which the gas G passing through the third purge passage Pp3 can be purged or its corresponding throttle-valve-opening degree Vs. The second effective-cross-sectional area A2 is greater than the first effective-cross-sectional area A1. Accordingly, the third effective-cross-sectional area A3 is greater than twice the first effective-cross-sectional area A1.

The engine-information-acquisition device 9 acquires information related to the engine 110. The engine-information-acquisition device 9 acquires the engine speed R or the throttle-valve-opening degree Vs. The engine-information-acquisition device 9 is electrically connected to the throttle valve 112, the engine speed sensor 113, and the crankshaft angle sensor 114. The engine-information-acquisition device 9 stores various programs and data for acquiring the throttle-valve-opening degree Vs, the engine speed R, and the crankshaft angle θ. The engine-information-acquisition device 9 can acquire the throttle-valve-opening degree Vs from the throttle valve 12, the engine speed R from the engine speed sensor 113, and the crankshaft angle θ from the crankshaft angle sensor 114.

The purge-amount-calculation device 10 calculates a purge amount that is an amount of the gas G to be purged into the intake pipe 111a. The purge-amount-calculation device 10 is electrically connected to the engine-information-acquisition device 9. The purge-amount-calculation device 10 stores various programs and data for calculating the purge amount of the gas G based on at least one of the engine speed R or the throttle-valve-opening degree Vs.

The purge-amount-calculation device 10 calculates the purge amount of the gas G based on at least one of the engine speed R or the throttle-valve-opening degree Vs acquired by the engine-information-acquisition device 9. Furthermore, the purge-amount-calculation device 10 selects, based on the calculated purge amount of the gas G, one of a recovery mode M0 in which the first purge control valve 7 is switched to the closed position Vc1 and held there and the second purge control valve 8 is switched to the closed position Vc2 and held there, a first purge mode M1 in which the first purge control valve 7 is switched to the open position Vo1 and held there and the second purge control valve 8 is switched to the closed position Vc2 and held there, a second purge mode M2 in which the first purge control valve 7 is switched to the closed position Vc1 and held there and the second purge control valve 8 is switched to the open position Vo2 and held there, or a third purge mode M3 in which the first purge control valve 7 is switched to the open position Vo1 and held there and the second purge control valve 8 is switched to the open position Vo2 and held there.

The valve control device 11 controls the opening and closing of the first purge control valve 7 and the second purge control valve 8. The valve control device 11 is electrically connected to the purge-amount-calculation device 10. The valve control device 11 is also electrically connected to the shutoff valve 2, the vent valve 5a, the first purge control valve 7, and the second purge control valve 8. The valve control device 11 stores various programs and data for controlling the opening and closing of the shutoff valve 2, the vent valve 5a, the first purge control valve 7, and the second purge control valve 8. The valve control device 11 controls the opening degree of the first purge control valve 7 and the second purge control valve 8, respectively, to switch each valve between the closed state and the open state. The valve control device 11 controls the opening and closing of the first purge control valve 7 and the second purge control valve 8, respectively, based on the mode selected by the purge-amount-calculation device 10.

The engine-information-acquisition device 9, the purge-amount-calculation device 10, and the valve control device 11 may be integrally configured to form a control device for the evaporative-emission-control system 1.

### Operation of Evaporative-Emission-Control System

A purge operation of the evaporative-emission-control system 1 will be described with reference to FIGS. 1 to 6. FIG. 2 is a schematic view of a state without supply of the gas G to the intake pipe 111a in the evaporative-emission-control system 1. FIG. 3 is a schematic view of a state where the gas G is supplied to the intake pipe 111a via the first purge passage Pp1 in the evaporative-emission-control system 1. FIG. 4 is a schematic view of a state where the gas G is supplied to the intake pipe 111a via the second purge passage Pp2 in the evaporative-emission-control system 1. FIG. 5 is a schematic view of a state where the gas G is supplied to the intake pipe 111a via the third purge passage Pp3 in the evaporative-emission-control system 1. FIG. 6 is a graph showing a relationship between the engine speed R and the effective-cross-sectional areas of the purge passages in the evaporative-emission-control system 1.

As shown in FIGS. 1 to 5, the purge-amount-calculation device 10 selects one of the recovery mode M0, the first purge mode M1, the second purge mode M2, or the third purge mode M3 for the first purge control valve 7 and the second purge control valve 8, based on at least one of the engine speed R or the throttle-valve-opening degree Vs acquired from the engine-information-acquisition device 9. The valve control device 11 opens or closes the first purge control valve 7 and the second purge control valve 8, respectively, based on the mode selected by the purge-amount-calculation device 10. The valve control device 11 also controls the opening and closing of the first purge control valve 7 and the second purge control valve 8 based on the crankshaft angle θ acquired from the engine-information-acquisition device 9.

As shown in FIG. 2, the recovery mode M0 causes the first purge control valve 7 to be switched to the closed position Vc1 and held there and the second purge control valve 8 to be switched to the closed position Vc2 and held there. The recovery mode M0 is a mode for recovering the gas G containing the evaporated fuel Gf by the canister 4 without purging it into the intake pipe 111a. For example, the recovery mode M0 is selected when the engine 110 is stopped or operates at an engine speed R less than 2,000 rpm excluding an idle speed immediately after the engine start.

As shown in FIG. 3, the first purge mode M1 causes the first purge control valve 7 to be switched to the open position Vo1 and held there and the second purge control valve 8 to be switched to the closed position Vc2 and held there. The first purge mode M1 is a mode for purging the gas G passing through the first purge passage Pp1 into the intake pipe 111a. The upper limit of the gas G purged into the intake pipe 111a in the first purge mode M1 is the lowest among the upper limits of the purge amounts in the first purge mode M1, the second purge mode M2, and the third purge mode M3. Thus, the first purge mode M1 is selected when the allowable fluctuation range of the air-fuel ratio of the engine 110 is the smallest. For example, the first purge mode M1 is selected when the engine speed R is within a relatively low engine speed range from 2,000 rpm to less than 3,000 rpm including the idle speed, or the throttle-valve-opening degree Vs is within a relatively small opening degree range including the minimum opening degree (under low load conditions).

As shown in FIG. 5, the third purge mode M3 causes the first purge control valve 7 to be switched to the open position Vo1 and held there and the second purge control valve 8 to be switched to the open position Vo2 and held there. The third purge mode M3 is a mode for purging the gas G passing through the third purge passage Pp3 into the intake pipe 111a. The upper limit of the gas G purged into the intake pipe 111a in the third purge mode M3 is the highest among the upper limits of the purge amounts in the first purge mode M1, the second purge mode M2, and the third purge mode M3. Thus, the third purge mode M3 is selected when the allowable fluctuation range of the air-fuel ratio of the engine 110 is the largest. For example, the third purge mode M3 is selected when the engine speed R is within a relatively high engine speed range of 5,000 rpm or higher including the maximum engine speed, or the throttle-valve-opening degree Vs is within a relatively large opening degree range including the maximum opening degree (under high load conditions).

As shown in FIG. 4, the second purge mode M2 causes the first purge control valve 7 to be switched to the closed position Vc1 and held there and the second purge control valve 8 to be switched to the open position Vo2 and held there. The second purge mode M2 is a mode for purging the gas G passing through the second purge passage Pp2 into the intake pipe 111a. The upper limit of the gas G purged into the intake pipe 111a in the second purge mode M2 is higher than the upper limit of the purge amount in the first purge mode M1 and lower than the upper limit of the purge amount in the third purge mode M3. Thus, the second purge mode M2 is selected, for example, when the engine speed R is within an intermediate engine speed range from 3,000 rpm to less than 5,000 rpm, or the throttle-valve-opening degree Vs is within an intermediate opening degree range (under intermediate load conditions).

As shown in FIGS. 1 to 5, when the evaporative-emission-control system 1 allows the engine 110 to combust the gas G containing the evaporated fuel Gf, the valve control device 11 switches the shutoff valve 2 and the vent valve 5a to the open state. Furthermore, the valve control device 11 control the opening and closing of the first purge control valve 7 and the second purge control valve 8, respectively, to be set to the mode selected by the purge-amount-calculation device 10 among from the recovery mode M0, the first purge mode M1, the second purge mode M2, and the third purge mode M3, based on at least one of the engine speed R or the throttle-valve-opening degree Vs.

As shown in FIG. 2, when the engine 110 is stopped, the purge-amount-calculation device 10 selects the recovery mode M0. The valve control device 11 controls the opening and closing of the first purge control valve 7 and the second purge control valve 8, respectively, so that the valves are at an opening degree as determined in the selected recovery mode M0. In the recovery mode M0, the evaporated fuel Gf generated in the fuel tank 115 passes through the fuel-tank-purge pipe 3 and flows into the canister 4. The evaporated fuel Gf flowing into the canister 4 is adsorbed by the activated carbon. The gas G, after the evaporated fuel Gf is adsorbed, is discharged into the atmosphere from the vent pipe 5. Thus, the evaporative-emission-control system 1 prevents the evaporated fuel Gf from being purged into the intake pipe 111a.

When the engine 110 is in operation, the purge-amount-calculation device 10 selects one of the recovery mode M0, the first purge mode M1, the second purge mode M2, or the third purge mode M3, based on at least one of the engine speed R or the throttle-valve-opening degree Vs acquired by the engine-information-acquisition device 9. The valve control device 11 controls the opening and closing of the first purge control valve 7 and the second purge control valve 8, respectively, so that each of the valves are at the open or closed position as determined in the mode selected by the purge-amount-calculation device 10. In the first purge mode M1, the second purge mode M2, and the third purge mode M3, the pressure in one of the first purge passage Pp1, the second purge passage Pp2, or the third purge passage Pp3, and the pressure in the canister 4 decrease with a decrease in pressure within the intake pipe 111a due to the operation of the engine 110. This allows the gas G in each of the purge passages and the canister 4 to be purged into the intake pipe 111a.

The decrease in pressure within the respective purge passages and the canister 4 causes the ambient air Ga to flow into the canister 4 from the vent pipe 5. The evaporated fuel Gf adsorbed by the activated carbon is released from the activated carbon by the ambient air Ga that has flowed in. The gas G, which is a mixture of the evaporated fuel Gf released from the activated carbon and the ambient air Ga, is purged from the intake purge pipe 6 into the intake pipe 111a. This enables the evaporative-emission-control system 1 to release the evaporated fuel Gf from the canister 4 and combust it in the engine 110, while increasing an amount of the evaporated fuel Gf that can be adsorbed by the canister 4.

As shown in FIG. 2, in the case of an engine speed R or throttle-valve-opening degree Vs at which the purge of the gas G containing the evaporated fuel Gf into the intake pipe 111a causes the air-fuel ratio of the engine 110 to fall outside an allowable range, the evaporative-emission-control system 1 recovers the evaporated fuel Gf by the canister 4 without purging the gas G into the intake pipe 111a. For example, when the engine 110 operates at an engine speed R less than 2,000 rpm excluding the idle speed, the purge-amount-calculation device 10 selects the recovery mode M0.

As shown in FIG. 3, the purge-amount-calculation device 10 selects the first purge mode M1 when the engine 110 operates within the relatively low engine speed range from 2,000 rpm to less than 3,000 rpm including the idle speed for the engine speed R, or within the relatively small opening degree range including the minimum opening degree for the throttle-valve-opening degree Vs. The valve control device 11 switches the first purge control valve 7 to the open position Vo1 and the second purge control valve 8 to the closed position Vc2 based on the crankshaft angle θ.

In this embodiment, the valve control device 11 switches the first purge control valve 7 to the open position Vo1 and the second purge control valve 8 to the closed position Vc2 at a crankshaft angle θ corresponding to an intake stroke of the engine 110, for example (see FIG. 1). The valve control device 11 also switches the first purge control valve 7 to the closed position Vc1 and the second purge control valve 8 to the closed position Vc2 at crankshaft angles θ corresponding to a compression stroke, a combustion stroke, and an exhaust stroke of the engine 110, for example. In the evaporative-emission-control system 1, the canister 4 and the first purge passage Pp1 communicate with the intake pipe 111a at a timing when the pressure in the intake pipe 111a decreases. That is, the evaporative-emission-control system 1 causes the gas G to be purged into the intake pipe 111a in the intake stroke when the pressure in the intake pipe 111a decreases, and the evaporated fuel Gf to be adsorbed by the canister 4 in the compression stroke, the combustion stroke and the exhaust stroke.

Thus, the evaporative-emission-control system 1 purges the gas G via the first purge passage Pp1 that can purge an amount of the gas G containing the evaporated fuel Gf into the intake pipe 111a, the amount being within a range in which the air-fuel ratio fluctuates within an allowable range, when the engine 110 operates within the relatively low engine speed range from 2,000 rpm to less than 3,000 rpm for the engine speed R or within the relatively small opening degree range including the minimum opening degree for the throttle-valve-opening degree Vs.

As shown in FIG. 4, the purge-amount-calculation device 10 selects the second purge mode M2 when the engine 110 operates, for example, within the intermediate engine speed range from 3,000 rpm to less than 5,000 rpm for the engine speed R or within the intermediate opening degree range for the throttle-valve-opening degree Vs. The valve control device 11 switches the first purge control valve 7 to the closed position Vc1 and the second purge control valve 8 to the open position Vo2 based on the crankshaft angle θ (see FIG. 1).

In this embodiment, the evaporative-emission-control system 1 causes the gas G to be purged into the intake pipe 111a via the second purge passage Pp2 in the intake stroke when the pressure in the intake pipe 111a decreases, and the evaporated fuel Gf to be adsorbed by the canister 4 in the compression stroke, the combustion stroke and the exhaust stroke.

Thus, the evaporative-emission-control system 1 purges the gas G into the intake pipe 111a via the second purge passage Pp2 that can purge an amount of the gas G containing the evaporated fuel Gf, the amount being within a range in which the air-fuel ratio fluctuates within an allowable range, when the engine 110 operates within the intermediate engine speed range from 3,000 rpm to less than 5,000 rpm for the engine speed R or within the intermediate opening degree range for the throttle-valve-opening degree Vs.

As shown in FIG. 5, the purge-amount-calculation device 10 selects the third purge mode M3 when the engine 110 operates within the relatively high engine speed range of 5,000 rpm or higher for the engine speed R or within the relatively large opening degree range including the maximum opening degree for the throttle-valve-opening degree Vs. The valve control device 11 switches the first purge control valve 7 to the open position Vo1 and the second purge control valve 8 to the open position Vo2 based on the crankshaft angle θ.

In this embodiment, the evaporative-emission-control system 1 causes the gas G to be purged into the intake pipe 111a via the third purge passage Pp3 in the intake stroke when the pressure in the intake pipe 111a decreases, and the evaporated fuel Gf to be adsorbed by the canister 4 in the compression stroke, the combustion stroke and the exhaust stroke.

Thus, the evaporative-emission-control system 1 purges the gas G into the intake pipe 111a via the third purge passage Pp3 that can purge an amount of the gas G containing the evaporated fuel Gf, the amount being within a range in which the air-fuel ratio fluctuates within an allowable range, when the engine 110 operates within the relatively high engine speed range of 5,000 rpm or higher for the engine speed R or within the relatively large opening degree range including the maximum opening degree for the throttle-valve-opening degree Vs.

As shown in FIGS. 5, 6 and 12, the intake purge pipe 6 of the evaporative-emission-control system 1 constitutes the passage having the third effective-cross-sectional area A3, which allows an amount of the gas G containing the evaporated fuel Gf to be purged into the intake pipe 111a, the amount being within a range in which the air-fuel ratio of the engine 110 fluctuates within an allowable range, for the relatively high engine speed range of 5,000 rpm or higher including the maximum engine speed of the engine 110, for example.

As shown in FIGS. 3, 6 and 12, the intake purge pipe 6 includes, as a part thereof, the first purge pipe 6b that constitutes the passage having the first effective-cross-sectional area A1, which allows an amount of the gas G containing the evaporated fuel Gf to be purged into the intake pipe 111a, the amount being within a range in which the air-fuel ratio of the engine 110 fluctuates within an allowable range, for the relatively low engine speed range from 2,000 rpm to less than 3,000 rpm above the idle speed of the engine 110, for example.

As shown in FIGS. 4, 6 and 12, the intake purge pipe 6 includes, as a part thereof, the second purge pipe 6c that is arranged in parallel with the first purge pipe 6b. The second purge pipe 6c constitutes the passage having the second effective-cross-sectional area A2 through which the gas G is purged in an amount greater than an amount that the first purge pipe 6b can purge into the intake pipe 111a and less than an amount that the intake purge pipe 6 can purge into the intake pipe 111a. For example, the second purge pipe 6c purges an amount of the gas G containing the evaporated fuel Gf into the intake pipe 111a, the amount being within a range in which the air-fuel ratio of the engine 110 fluctuates within an allowable range, for a range from 3,000 rpm to less than 5,000 rpm for the engine speed R, for example.

The evaporative-emission-control system 1 switches the purge amount of the gas G purged into the intake pipe 111a among four levels through a combination of a two-level switching method and a multi-level switching method. The two-level switching method selects either the first purge mode M1 for purging the gas G that has passed through the first purge pipe 6b into the intake pipe 111a, or the second purge mode M2 for purging the gas G that has passed through the second purge pipe 6c into the intake pipe 111a. The multi-level switching method changes the purge amount of the gas G purged into the intake pipe 111a to zero, a small amount, or a large amount by switching to one of the recovery mode M0 for preventing the gas G from passing through the intake purge pipe 6, the first purge mode M1 for purging the gas G that has passed through the first purge pipe 6b into the intake pipe 111a, or the third purge mode M3 for purging into the intake pipe 111a the gas G that has passed through the intake purge pipe 6 including the first purge pipe 6b and the second purge pipe 6c.

In this manner, the evaporative-emission-control system 1 selects one of the third purge passage Pp3 having the third effective-cross-sectional area A3, which is the largest among the purge passages, the first purge passage Pp1 having the first effective-cross-sectional area A1, which is the smallest, or the second purge passage Pp2 having the second effective-cross-sectional area A2, which is obtained by subtracting the first effective-cross-sectional area A1 from the third effective-cross-sectional area A3, thereby adjusting the purge amount of the gas G precisely in a range from a relatively low engine speed R including an idle speed to a relatively high engine speed R including the maximum engine speed (see FIG. 6). This enables continued adsorption of the evaporated fuel Gf by the canister 4 by efficiently releasing the evaporated fuel Gf from the canister 4, while suppressing fluctuation in the air-fuel ratio of the engine 110 so that the air-fuel ratio fluctuates within a predetermined range.

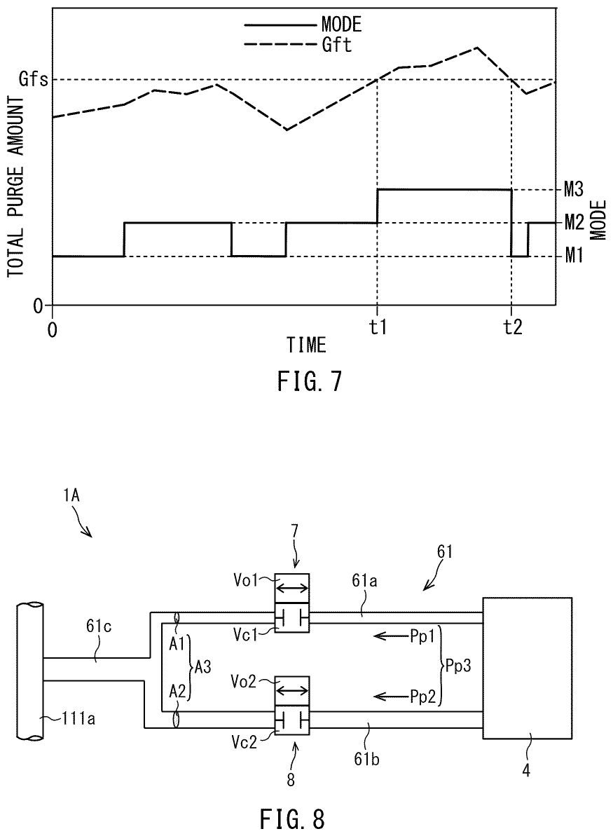

With reference to FIGS. 1 and 7, a relationship between the evaporated fuel Gf adsorbed by the canister 4 and a total purge amount Gft will now be described. FIG. 7 is a graph showing a relationship between the total purge amount Gft in a predetermined time period and a purge mode to be selected in the evaporative-emission-control system 1. When it is estimated that the air-fuel ratio fluctuates within an allowable range even when the evaporated fuel Gf adsorbed by the canister 4 is purged into the intake pipe 111a in the third purge mode M3, the evaporative-emission-control system 1 purges the evaporated fuel Gf into the intake pipe 111a in the third purge mode M3.

As shown in FIGS. 1 and 7, the estimated maximum amount of the evaporated fuel Gf adsorbed by the canister 4 after a predetermined time period has elapsed following the purge of the evaporated fuel Gf is a difference between a sum of the maximum amount of the evaporated fuel Gf that can be adsorbed by the canister 4 and the maximum amount of the evaporated fuel Gf newly generated in the fuel tank 115 within the predetermined time period, and the total purge amount Gft that is a total amount of the evaporated fuel Gf contained in the gas G purged into the intake pipe 111a within the predetermined time period. On the other hand, a concentration of the evaporated fuel Gf contained in the gas G (hereinafter simply referred to as “the concentration of the evaporated fuel Gf”) decreases with a decrease in the evaporated fuel Gf adsorbed by the canister 4. The maximum amount of the evaporated fuel Gf that can be adsorbed by the canister 4 and the maximum amount of the evaporated fuel Gf newly generated in the fuel tank 115 within the predetermined time period are respectively constant. Accordingly, the concentration of the evaporated fuel Gf purged into the intake pipe 111a depends on the total purge amount Gft of the evaporated fuel Gf purged within the predetermined time period. The concentration of the evaporated fuel Gf decreases as the total purge amount Gft increases.

The purge-amount-calculation device 10 calculates, for each unit time period, the total purge amount Gft within the predetermined time period ending at the unit time period. When the calculated total purge amount Gft is equal to or greater than a reference-total-purge amount Gfs, which is a reference value of the total purge amount at which it is estimated that the evaporated fuel Gf is purged in such an amount that fluctuation in the air-fuel ratio of the engine 110 can be suppressed so that the air-fuel ratio fluctuates within a predetermined range, the purge-amount-calculation device 10 determines that, even when the purge amount is increased, fluctuation in the air-fuel ratio of the engine 110 is suppressed so that the air-fuel ratio fluctuates within the predetermined range. That is, the purge-amount-calculation device 10 determines that the evaporated fuel Gf has a concentration such that the air-fuel ratio of the engine 110 fluctuates within the predetermined range even when the purge amount is increased. When the total purge amount Gft is equal to or greater than the reference-total-purge amount Gfs, the valve control device 11 switches the first purge control valve 7 to the open position Vo1 and the second purge control valve 8 to the open position Vo2 (corresponding to the third purge mode M3). This enables the evaporative-emission-control system 1 to efficiently release the evaporated fuel Gf adsorbed by the canister 4 in such a manner that the air-fuel ratio of the engine 110 remains unaffected.

As shown in FIG. 7, the total purge amount Gft calculated by the purge-amount-calculation device 10 is equal to or greater than the reference-total-purge amount Gfs at a time t1. Thus, the purge-amount-calculation device 10 selects the third purge mode M3 irrespective of the engine speed R or the throttle-valve-opening degree Vs. The valve control device 11 switches the first purge control valve 7 to the open position Vo1 and holds it there, and switches the second purge control valve 8 to the open position Vo2 and holds it there. The total purge amount Gft calculated by the purge-amount-calculation device 10 is less than the reference-total-purge amount Gfs at a time t2. Thus, the purge-amount-calculation device 10 selects the first purge mode M1 based on at least one of the engine speed R or the throttle-valve-opening degree Vs.

In this manner, when fluctuation in the air-fuel ratio of the engine 110 is suppressed so that the air-fuel ratio fluctuates within a predetermined range, the evaporative-emission-control system 1 switches to the third purge mode M3, thereby increasing the purge amount of the gas G. The evaporative-emission-control system 1 can ensure the total purge amount Gft necessary for continued adsorption of the evaporated fuel Gf by the canister 4 by efficiently releasing the evaporated fuel Gf from the canister 4, while mitigating influence on the engine 110.

As shown in FIGS. 1 to 5, the valve control device 11 controls the first purge control valve 7 and the second purge control valve 8, respectively, such that they are switched between the open position Vo1 or Vo2 and the closed position Vc1 or Vc2 at a predetermined crankshaft angle θ. For example, the valve control device 11 switches the first purge control valve 7 and the second purge control valve 8 to the respective open positions Vo1 and Vo2 immediately before opening the intake valve of the engine 110, while switching the first purge control valve 7 and the second purge control valve 8 to the respective closed positions Vc1 and Vc2 immediately before closing the intake valve of the engine 110. This enables the evaporative-emission-control system 1 to purge the gas G into the intake pipe 111a in synchronization with the intake timing and the exhaust timing of the engine 110, irrespective of fluctuation in the engine speed R caused by a load. In this manner, the total purge amount Gft can be maintained by efficiently releasing the evaporated fuel Gf from the canister 4 in accordance with the intake and exhaust timings of the engine 110.

### First Variation of First Embodiment

An evaporative-emission-control system 1A, which is a first variation of the first embodiment, will be described with reference to FIG. 8. FIG. 8 is a schematic view of a configuration of a purge pipe 61 for the intake pipe (intake purge pipe 61) in the evaporative-emission-control system 1A.

As shown in FIG. 8, the evaporative-emission-control system 1A includes the intake purge pipe 61 in substitution for the intake purge pipe 6.

The intake purge pipe 61 serves to flow the gas G containing the evaporated fuel Gf and the ambient air Ga in the canister 4 into the intake pipe 111a of the engine 110 (see FIG. 1). One end of the intake purge pipe 61 is connected to the canister 4. The other end of the intake purge pipe 61 is connected to the intake pipe 111a. The intake purge pipe 61 includes a branched portion that bifurcates between the one end and the other end thereof. Thus, the intake purge pipe 61 includes a first purge pipe 61a and a second purge pipe 61b that constitute the branched portion at the one end thereof connected to the canister 4, and a downstream purge pipe 61c that extends from the branched portion to the other end thereof connected to the intake pipe 111a.

One end of the first purge pipe 61a and one end of the second purge pipe 61b are respectively connected to the canister 4. The other end of the first purge pipe 61a and the other end of the second purge pipe 61b are respectively connected to one end of the downstream purge pipe 6c. The other end of the downstream purge pipe 61c is connected to the intake pipe 111a. The first purge pipe 61a and the second purge pipe 61b are connected to the canister 4 and the downstream purge pipe 61c, respectively, such that the first purge pipe 61a and the second purge pipe 61b are arranged in parallel. Thus, the intake purge pipe 61 through which the evaporated fuel Gf and the ambient air Ga flow constitutes a part of the gas passage.

The first purge control valve 7 is provided at an arbitrary position along the first purge pipe 61a. The second purge control valve 8 is provided at an arbitrary position along the second purge pipe 61b.

An effective-cross-sectional area of the first purge pipe 61a is a first effective-cross-sectional area A1. An effective-cross-sectional area of the second purge pipe 61b is a second effective-cross-sectional area A2. An effective-cross-sectional area of the downstream purge pipe 61c is equal to or greater than a sum of the first effective-cross-sectional area A1 of the first purge pipe 61a and the second effective-cross-sectional area A2 of the second purge pipe 61b. The second effective-cross-sectional area A2 of the second purge pipe 61b is greater than the first effective-cross-sectional area A1 of the first purge pipe 61a.

An effective-cross-sectional area of a third purge passage Pp3 is a third effective-cross-sectional area A3 that is the sum of the first effective-cross-sectional area A1 of the first purge pipe 61a and the second effective-cross-sectional area A2 of the second purge pipe 61b.

An effective-cross-sectional area of a first purge passage Pp1 is the first effective-cross-sectional area A1 of the first purge pipe 61a. An effective-cross-sectional area of a second purge passage Pp2 is the second effective-cross-sectional area A2 of the second purge pipe 61b. The evaporative-emission-control system 1A forms the first purge passage Pp1, the second purge passage Pp2, and the third purge passage Pp3, which have the different effective-cross-sectional areas, by switching each of the first purge control valve 7 and the second purge control valve 8 to the open or closed position and holding them in their respective switched positions.

### Second Variation of First Embodiment

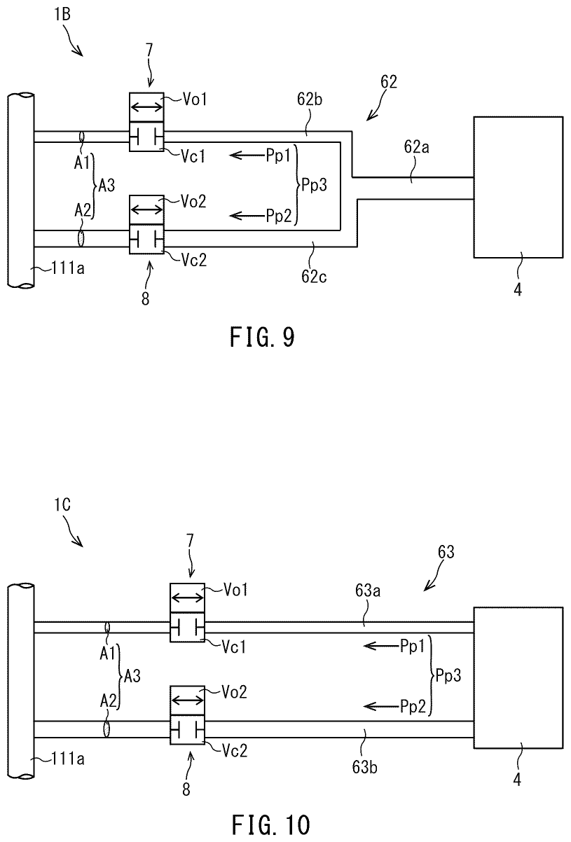

An evaporative-emission-control system 1B, which is a second variation of the first embodiment, will be described with reference to FIG. 9. FIG. 9 is a schematic view of a configuration of a purge pipe 62 for the intake pipe (intake purge pipe 62) in the evaporative-emission-control system 1B.

As shown in FIG. 9, the evaporative-emission-control system 1B includes the intake purge pipe 62 in substitution for the intake purge pipe 6.

The intake purge pipe 62 serves to flow the gas G containing the evaporated fuel Gf and the ambient air Ga in the canister 4 into the intake pipe 111a of the engine 110 (see FIG. 1). One end of the intake purge pipe 62 is connected to the canister 4. The other end of the intake purge pipe 62 is connected to the intake pipe 111a. The intake purge pipe 62 includes a branched portion that bifurcates between the one end and the other end thereof. Thus, the intake purge pipe 62 includes an upstream purge pipe 62a that extends from the one end thereof connected to the canister 4 to the branched portion, as well as a first purge pipe 62b and a second purge pipe 62c that constitute the branched portion at the other end thereof connected to the intake pipe 111a.

One end of the upstream purge pipe 62a is connected to the canister 4. The other end of the upstream purge pipe 62a is connected to one end of the first purge pipe 62b and one end of the second purge pipe 62c, respectively. The other end of the first purge pipe 62b and the other end of the second purge pipe 62c are respectively connected to the intake pipe 111a. The first purge pipe 62b and the second purge pipe 62c are connected to the upstream purge pipe 62a and the intake pipe 111a, respectively, such that the first purge pipe 62b and the second purge pipe 62c are arranged in parallel. Thus, the intake purge pipe 62 through which the evaporated fuel Gf and the ambient air Ga flow constitutes a part of the gas passage.

The first purge control valve 7 is provided at an arbitrary position along the first purge pipe 62b. The second purge control valve 8 is provided at an arbitrary position along the second purge pipe 62c.

An effective-cross-sectional area of the first purge pipe 62b is a first effective-cross-sectional area A1. An effective-cross-sectional area of the second purge pipe 62c is a second effective-cross-sectional area A2. An effective-cross-sectional area of the upstream purge pipe 62a to which the first purge pipe 62b and the second purge pipe 62c are connected is equal to or greater than a sum of the first effective-cross-sectional area A1 of the first purge pipe 62b and the second effective-cross-sectional area A2 of the second purge pipe 62c. The second effective-cross-sectional area A2 of the second purge pipe 62c is greater than the first effective-cross-sectional area A1 of the first purge pipe 62b.

An effective-cross-sectional area of a third purge passage Pp3 is a third effective-cross-sectional area A3 that is the sum of the first effective-cross-sectional area A1 of the first purge pipe 62b and the second effective-cross-sectional area A2 of the second purge pipe 62c.

An effective-cross-sectional area of a first purge passage Pp1 is the first effective-cross-sectional area A1 of the first purge pipe 62b. An effective-cross-sectional area of a second purge passage Pp2 is the second effective-cross-sectional area A2 of the second purge pipe 62c. The evaporative-emission-control system 1B forms the first purge passage Pp1, the second purge passage Pp2, and the third purge passage Pp3, which have the different effective-cross-sectional areas, by switching each of the first purge control valve 7 and the second purge control valve 8 to the open or closed position and holding them in their respective switched positions.

### Third Variation of First Embodiment

An evaporative-emission-control system 1C, which is a third variation of the first embodiment, will be described with reference to FIG. 10. FIG. 10 is a schematic view of a configuration of a purge pipe 63 for the intake pipe (intake purge pipe 63) in the evaporative-emission-control system 1C.

As shown in FIG. 10, the evaporative-emission-control system 1C includes the intake purge pipe 63 in substitution for the intake purge pipe 6.

The intake purge pipe 63 serves to flow the gas G containing the evaporated fuel Gf and the ambient air Ga in the canister 4 into the intake pipe 111a of the engine 110. One end of the intake purge pipe 63 is connected to the canister 4. The other end of the intake purge pipe 63 is connected to the intake pipe 111a. The intake purge pipe 63 is formed by a first purge pipe 63a and a second purge pipe 63b. The first purge pipe 63a and the second purge pipe 63b are arranged in parallel. One end of the first purge pipe 63a and one end of the second purge pipe 63b are respectively connected to the canister 4. The other end of the first purge pipe 63a and the other end of the second purge pipe 63b are respectively connected to the intake pipe 111a. Thus, the intake purge pipe 63 through which the evaporated fuel Gf and the ambient air Ga flow constitutes a part of the gas passage.

The first purge control valve 7 is provided at an arbitrary position along the first purge pipe 63a. The second purge control valve 8 is provided at an arbitrary position along the second purge pipe 63b.

An effective-cross-sectional area of the first purge pipe 63a is a first effective-cross-sectional area A1. An effective-cross-sectional area of the second purge pipe 63b is a second effective-cross-sectional area A2. The second effective-cross-sectional area A2 of the second purge pipe 63b is greater than the first effective-cross-sectional area A1 of the first purge pipe 63a.

An effective-cross-sectional area of a third purge passage Pp3 is a third effective-cross-sectional area A3 that is a sum of the first effective-cross-sectional area A1 of the first purge pipe 63a and the second effective-cross-sectional area A2 of the second purge pipe 63b.

An effective-cross-sectional area of a first purge passage Pp1 is the first effective-cross-sectional area A1 of the first purge pipe 63a. An effective-cross-sectional area of a second purge passage Pp2 is the second effective-cross-sectional area A2 of the second purge pipe 63b. The evaporative-emission-control system 1C forms the first purge passage Pp1, the second purge passage Pp2, and the third purge passage Pp3, which have the different effective-cross-sectional areas, by switching each of the first purge control valve 7 and the second purge control valve 8 to the open or closed position and holding them in their respective switched positions.

### Second Embodiment

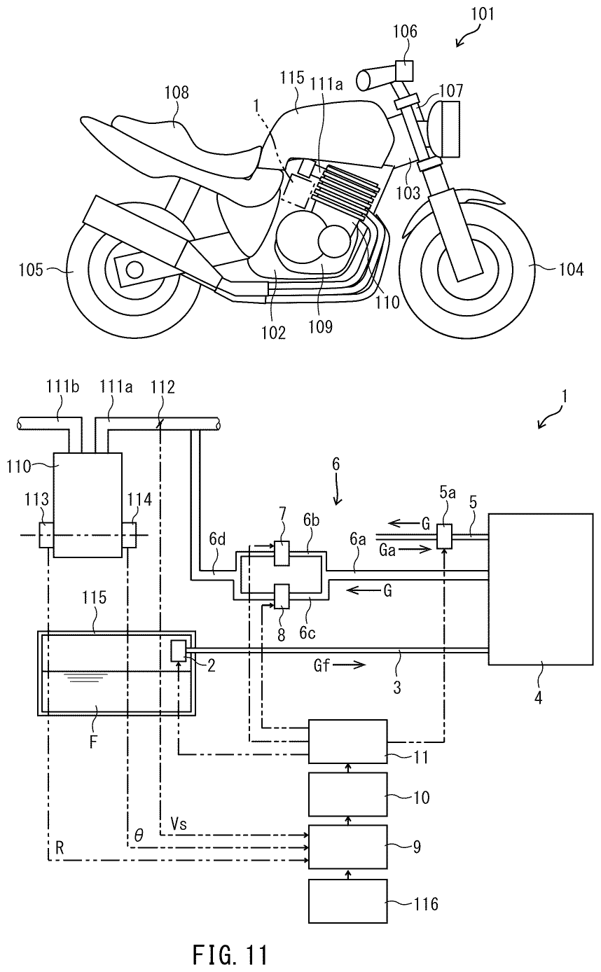

A vehicle 101, which is a straddled vehicle, according to the present teaching will be described with reference to FIG. 11. FIG. 11 is a schematic view of a configuration of the vehicle 101 including the evaporative-emission-control system 1, according to a second embodiment of the present teaching. The vehicle 101 is a motorcycle, for example. The vehicle 101 includes a vehicle body frame 102, a front wheel 104, and a rear wheel 105. The vehicle 101 turns in a leaned posture. That is, the vehicle 101 leans leftward when turning to the left and leans rightward when turning to the right.

As shown in FIG. 11, the vehicle body frame 102 supports components, such as the evaporative-emission-control system 1, a handlebar 106, a steering shaft 107, a seat 108, a transmission 109, the engine 110, and the fuel tank 115. The vehicle body frame 102 includes a head tube 103. The vehicle body frame 102 is arranged to extend in a front-rear direction of the vehicle 101. The vehicle body frame 102 includes a portion extending rearward and upward of the vehicle 101, and a portion extending rearward and downward of the vehicle 101.

The head tube 103 is connected to a front portion of the vehicle body frame 102. The fuel tank 115 for storing a fuel of the engine 110 is fixed to an upper forward portion of the vehicle body frame 102 so as to be positioned at a center in a left-right direction of the vehicle 101. The seat 108 on which a driver is seated is arranged in the portion extending rearward and upward of the vehicle body frame 102 behind the fuel tank 115 so as to be positioned at the center in the left-right direction of the vehicle 101.

The transmission 109 and the engine 110 are supported by a lower portion of the vehicle body frame 102. The intake pipe 111a as an intake passage and the exhaust pipe 111b (see FIG. 3) are connected to the engine 110. The engine 110 includes the engine speed sensor 113 for detecting the engine speed R, and the crankshaft angle sensor 114 for detecting the crankshaft angle θ of the engine 110.

The head tube 103 is located in a front portion of the vehicle 101. The head tube 103 is connected to a front end portion of the vehicle body frame 102. The head tube 103 rotatably supports the steering shaft 107. The steering shaft 107 is connected to the handlebar 106 for steering the front wheel 104. The front wheel 104 is rotatably supported by a lower portion of the steering shaft 107. The rear wheel 105 is rotatably supported by a rear portion of the vehicle body frame 102. A driving force is transmitted to the rear wheel 105 from the transmission 109.

The evaporative-emission-control system 1 is supported by the vehicle body frame 102. The fuel tank 115 is connected to the canister 4 via the fuel-tank-purge pipe 3 that serves as the fuel-tank-purge passage. The intake pipe 111a of the engine 110 is connected to the canister 4 via the intake purge pipe 6 including the first purge pipe 6b and the second purge pipe 6c. The engine-information-acquisition device 9 is electrically connected to the throttle valve 112, the engine speed sensor 113, and the crankshaft angle sensor 114. The engine-information-acquisition device 9 is also electrically connected to an engine control device 116 for the engine 110. The engine control device 116 is configured to transmit information related to the engine 110 to the engine-information-acquisition device 9.

The evaporative-emission-control system 1 causes the engine-information-acquisition device 9 to acquire at least one of the engine speed R detected by the engine speed sensor 113 or the throttle-valve-opening degree Vs of the engine 110. The evaporative-emission-control system 1 causes the first purge control valve 7 and the second purge control valve 8 to operate based on operation of the engine 110. Thus, the evaporative-emission-control system 1 calculates the purge amount of the gas G containing the evaporated fuel Gf to be purged into the intake pipe 111a based on the acquired engine speed R or throttle-valve-opening degree Vs. This allows the total purge amount Gft of the evaporated fuel Gf in the evaporative-emission-control system 1 to be maintained, while suppressing fluctuation in the air-fuel ratio of the engine 110 so that the air-fuel ratio fluctuates within an allowable range.

### Other Embodiments

In the embodiments described above, the evaporative-emission-control system 1 includes the first purge passage Pp1, the second purge passage Pp2, and the third purge passage Pp3 as the plurality of parge passages. Alternatively, the evaporative-emission-control system may include four purge passages or more as the plurality of purge passages.

In the first embodiment described above, the evaporative-emission-control system 1 includes the first purge pipe 6b and the second purge pipe 6c that purge the gas G into the intake pipe 111a from the canister 4. Alternatively, the evaporative-emission-control system may include three purge pipes or more for purging the gas G into the intake pipe 111a from the canister.

In the first embodiment described above, the evaporative-emission-control system 1 switches the first purge pipe 6b and the second purge pipe 6c, respectively, between the closed state and the open state by the first purge control valve 7 and the second purge control valve 8 that are the on-off valves. Alternatively, the first purge control valve 7 and the second purge control valve 8 may be proportional control valves capable of being open and closed to arbitrary opening degrees.

In the first embodiment described above, the evaporative-emission-control system 1 is configured such that the second effective-cross-sectional area A2 of the second purge pipe 6c is greater than the first effective-cross-sectional area A1 of the first purge pipe 6b. Alternatively, the effective-cross-sectional area of the second purge pipe may be less than the effective-cross-sectional area of the first purge pipe. That is, it is sufficient that the effective-cross-sectional area of the second purge pipe and the effective-cross-sectional area of the first purge pipe are different from each other.

In the first embodiment described above, the engine-information-acquisition device 9, the purge-amount-calculation device 10, and the valve control device 11 are configured as a control device of the evaporative-emission-control system 1. Alternatively, at least one of the engine-information-acquisition device, the purge-amount-calculation device, or the valve control device may be configured integrally with an engine control device for the engine.

In the first and second embodiments described above, the engine-information-acquisition device 9 acquires the engine speed R from the engine speed sensor 113, the throttle-valve-opening degree Vs from the throttle valve 112, and the crankshaft angle θ from the crankshaft angle sensor 114. Alternatively, the engine-information-acquisition device may be configured to acquire the engine speed R, the throttle-valve-opening degree Vs, and the crankshaft angle θ from an engine control device.

In the first embodiment described above, the recovery mode M0 is selected when the engine 110 operates at the engine speed R of less than 2,000 rpm excluding the idle speed, for example. The first purge mode M1 is selected when the engine 110 operates at the engine speed R of from 2,000 rpm to less than 3,000 rpm including the idle speed, for example. The second purge mode M2 is selected when the engine 110 operates at the engine speed R of from 3,000 rpm to less than 5,000 rpm, for example. The third purge mode M3 is selected when the engine 110 operates at the engine speed R of 5,000 rpm or higher including the maximum engine speed, for example. Alternatively, the engine speeds or the throttle-valve-opening degrees to which the recovery mode, the first purge mode, the second purge mode, and the third purge mode are respectively applied may be set to values based on engine performance, engine characteristics, operating environment, canister capability, fuel tank capacity, fuel type, seasons, the scope of legal regulations, or other factors. Alternatively, one of the modes may be selected depending on conditions other than the engine speeds or the throttle-valve-opening degrees.

The embodiments of the present teaching have been described above, but the above-described embodiments are merely illustrative examples for carrying out the present teaching. Therefore, the present teaching is not limited to the above-described embodiments, and the above-described embodiments can be appropriately modified and implemented without departing from the gist of the present teaching.

### REFERENCE SIGNS LIST

1, 1A, 1B, 1C evaporative-emission-control system
2 shutoff valve
3 fuel-tank-purge pipe (purge pipe for fuel tank)
4 canister
5 vent pipe
5a vent valve
6, 61, 62, 63 intake purge pipe (purge pipe for intake pipe)
6a, 62a upstream purge pipe
6b, 61a, 62b, 63a first purge pipe
6c, 61b, 62c, 63b second purge pipe
6d, 61c downstream purge pipe
7 first purge control valve
8 second purge control valve
9 engine-information-acquisition device
10 purge-amount-calculation device
11 valve control device
101 vehicle
102 vehicle body frame
103 head tube
104 front wheel
105 rear wheel
106 handlebar
107 steering shaft
108 seat
109 transmission
110 engine
111a intake pipe
111b exhaust pipe
112 throttle valve
113 engine speed sensor
114 crankshaft angle sensor
115 fuel tank
116 engine control device
M0 recovery mode
M1 first purge mode
M2 second purge mode
M3 third purge mode
Pp1 first purge passage
Pp2 second purge passage
Pp3 third purge passage
Vo1, Vo2 open position
Vc1, Vc2 closed position
R engine speed
Vs throttle-valve-opening degree
θ crankshaft angle
G gas
F fuel
Gf evaporated fuel
Ga ambient air
Gft total purge amount
Gfs reference-total-purge amount
t1, t2 time

1. An evaporative-emission-control system, comprising:
a canister configured to recover an evaporated fuel generated in a fuel tank that stores a fuel of an engine;
a fuel-tank-purge passage configured to guide the evaporated fuel into the canister;
an ambient-air-introduction passage configured to introduce an ambient air into the canister;
a first purge passage and a second purge passage, configured to purge a gas from the canister into an intake passage of the engine, the gas from the canister containing at least one of the recovered evaporated fuel or the ambient air introduced via the ambient-air-introduction passage;
a first opening/closing valve configured to switch between a closed position in which the first purge passage is blocked and an open position in which the first purge passage is open;
a second opening/closing valve configured to switch between a closed position in which the second purge passage is blocked and an open position in which the second purge passage is open;
an engine-information-acquisition device configured to acquire at least one of an engine speed of the engine or a throttle-valve-opening degree of the engine;
a purge-amount-calculation device configured to determine whether each of the first opening/closing valve and the second opening/closing valve is in the open position thereof or the closed position thereof; and
a valve control device configured to control opening and closing of each of the first opening/closing valve and the second opening/closing valve, to thereby form a plurality of purge passages through which the gas passes in the evaporative-emission-control system, wherein
each of the plurality of purge passages has an effective-cross-sectional area,
the plurality of purge passages includes the first purge passage and the second purge passage,
the effective-cross-sectional area of the first purge passage is a first effective-cross-sectional area, which is smallest among the effective-cross-sectional areas of the plurality of purge passages,
the effective-cross-sectional area of the second purge passage is a second effective-cross-sectional area, which is obtained by subtracting the first effective-cross-sectional area from a third effective-cross-sectional area, the third effective-cross-sectional area being a sum of the effective-cross-sectional areas of the plurality of the purge passages, wherein
the purge-amount-calculation device is configured to select, based on at least one of the engine speed or the throttle-valve-opening degree acquired by the engine-information-acquisition device, a mode among:
a recovery mode in which the first opening/closing valve is switched to, and remains in, the closed position, and the second opening/closing valve is switched to, and remains in, the closed position, to thereby recover the evaporated fuel by the canister without supplying the evaporated fuel to the engine,
a first purge mode in which the first opening/closing valve is switched to, and remains in, the open position, and the second opening/closing valve is switched to, and remains in, the closed position, to thereby supply the gas to the engine through the first purge passage,
a second purge mode in which the first opening/closing valve is switched to, and remains in, the closed position, and the second opening/closing valve is switched to, and remains in, the open position, to thereby supply the gas to the engine through the second purge passage, and
a third purge mode in which the first opening/closing valve is switched to, and remains in, the open position, and the second opening/closing valve is switched to, and remains in, the open position, to thereby supply the gas to the engine through the first purge passage and the second purge passage, and
the valve control device is configured to control the opening and closing of the first opening/closing valve and the second opening/closing valve in accordance with the selected mode.

2. The evaporative-emission-control system according to claim 1, wherein the first purge passage allows an amount of the gas containing the evaporated fuel to pass therethrough, to thereby maintain continued combustion in the engine, in at least one of a state where the engine speed is equal to or greater than an idle speed or a state where the throttle-valve-opening degree is equal to or greater than an opening degree for maintaining the idle speed.

3. The evaporative-emission-control system according to claim 1, wherein the second effective-cross-sectional area is greater than the first effective-cross-sectional area.

4. The evaporative-emission-control system according to claim 1, wherein
the engine-information-acquisition device is further configured to acquire a crankshaft angle of the engine, and
the valve control device is configured to control the opening and closing of each of the first opening/closing valve and the second opening/closing valve based on the crankshaft angle acquired by the engine-information-acquisition device.

5. The evaporative-emission-control system according to claim 1, wherein
the purge-amount-calculation device is configured to
calculate a total amount of the evaporated fuel contained in the gas purged into the intake passage within a predetermined time period as a total purge amount, based on at least one of the engine speed or the throttle-valve-opening degree, and on the first effective-cross-sectional area or the second effective-cross-sectional area, and
select the third purge mode in a case where the total purge amount is equal to or greater than a reference-total-purge amount at which fluctuation in an air-fuel ratio of the engine is suppressed so that the air-fuel ratio fluctuates within a predetermined range.

6. A straddled vehicle including the evaporative-emission-control system according to claim 1, the straddled vehicle comprising:
an engine;
a fuel tank configured to store a fuel of the engine; and
an engine control device, wherein
the fuel tank is connected to the canister via the fuel-tank-purge passage,
the engine has an intake passage that is connected to the canister via the first purge passage and the second purge passage, and
at least one of the engine speed or the throttle-valve-opening degree
is transmitted from the engine control device to the engine-information-acquisition device, or
is acquired by the engine-information-acquisition device, the engine speed being detected by an engine speed sensor of the engine.
